(19) United States
(12) Patent Application Publication
(10) Pub. No.: US 2024/0338970 A1
(43) Pub. Date: Oct. 10, 2024

(54) SYSTEMS AND METHODS FOR MONITORING ENVIRONMENTS OF VEHICLES

(71) Applicant: SAUDI ARABIAN OIL COMPANY, Dhahran (SA)

(72) Inventor: Abdullah Mohammed ALANAZI, Dhahran (SA)

(73) Assignee: SAUDI ARABIAN OIL COMPANY, Dhahran (SA)

(21) Appl. No.: 18/298,214

(22) Filed: Apr. 10, 2023

(51) Int. Cl. G06V 40/16; B60R 25/04; G06V 20/58; G06V 20/59

(52) U.S. Cl. CPC G06V 40/172; B60R 25/04; G06V 20/58; G06V 20/59; B60R 2025/0405

(57) ABSTRACT

In some examples, a monitoring tool, implemented by a processor, is configured to determine whether a behavior inferred from capture of information by one or more sensors of a vehicle complies with one or more health, safety, and environment (HSE) policies using one or more machine learning techniques, and generate a report including at least one of the behavior, an indication of whether the behavior complies with the one or more HSE policies, an HSE policy of the one or more HSE policies with which the behavior violates, or a combination thereof.

### FIELD OF THE DISCLOSURE

The present description relates generally to monitoring environments of vehicles.

### BACKGROUND OF THE DISCLOSURE

For safety and security reasons, vehicles are equipped with one or more image sensors. The one or more image sensors are positioned to capture images of an environment of the vehicle. The images are used to detect potentially hazardous conditions (e.g., another vehicle in a blind spot, proximity to another vehicle, obstacle in vehicle's path).

### SUMMARY OF THE DISCLOSURE

Various details of the present disclosure are hereinafter summarized to provide a basic understanding. This summary is not an extensive overview of the disclosure and is neither intended to identify certain elements of the disclosure, nor to delineate the scope thereof. Rather, the purpose of this summary is to present some concepts of the disclosure in a simplified form prior to the more detailed description that is presented hereinafter.

According to an embodiment of the present disclosure, a monitoring tool, implemented by a processor, is configured to determine whether a behavior inferred from capture of information by one or more sensors of a vehicle complies with one or more health, safety, and environment (HSE) policies using one or more machine learning techniques, and generate a report including at least one of the behavior, an indication of whether the behavior complies with the one or more HSE policies, an HSE policy of the one or more HSE policies with which the behavior violates, or a combination thereof.

In another embodiment of the present disclosure, a method includes live-streaming one or more images captured by one or more image sensors; verifying at least one of an identity of a driver of a first vehicle or a license plate of a second vehicle based on at least one of the one or more images or other sensor information using one or more machine learning techniques; and generating a report including the at least one of the identity of the driver of the first vehicle or the license plate of the second vehicle.

According to another embodiment of the present disclosure, a computer-readable medium stores machine-readable instructions, which when executed by a processor, cause the processor to determine whether a behavior inferred from capture of one or more images or other sensor information of a vehicle complies with one or more health, safety, and environment (HSE) policies using one or more machine learning techniques, and generate a report including at least one of the behavior, an indication of whether the behavior complies with the one or more HSE policies, an HSE policy of the one or more HSE policies with which the behavior violates, or a combination thereof.

Any combinations of the various embodiments and implementations described herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is a block diagram of a system for monitoring an environment of a vehicle, in

accordance with certain embodiments.

FIG. 2 is an example system for monitoring an environment of a vehicle, in accordance with certain embodiments.

FIG. 3 is an example output of a system or method for monitoring an environment of a vehicle, in accordance with certain embodiments.

FIG. 4 is a block diagram of a computer system that can be employed to execute a system or method for monitoring an environment of a vehicle, in accordance with certain embodiments.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments described herein may be practiced without these specific details.

In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

As described above, vehicles may use images captured by one or more image sensors to detect potential hazards in an environment of a vehicle. Health, safety, and environmental (HSE) regulations and policies provide guidelines that assist in reducing accidents and losses (e.g., time, property) and improving occupational conditions in an organization's operating environment, where a vehicle patrols the operating environment. The operating environment may be an industrial facility, such as a petrochemical plant, for example. Embodiments in accordance with the present disclosure generally relate to systems and methods for monitoring environments of vehicles. In non-limiting examples, a system includes a vehicle including multiple image sensors and a network interface and a monitoring tool to monitor the environment of the vehicle. The environment of the vehicle, as used herein, includes one or more areas captured by a field of view of an image sensor of the vehicle. The environment of the vehicle includes an interior of the vehicle (e.g., a cabin of the vehicle, a driver of the vehicle, one or more passengers of the vehicle), an exterior of the vehicle (e.g., outer components of the vehicle, items within specified distances of the vehicle), or a combination thereof.

The monitoring tool may be implemented by a processor-based device executing machine-readable instructions. The machine-readable instructions may implement a model determined using one or more machine learning techniques, for example. The monitoring tool may be included in the vehicle or may be remote to the vehicle. In a non-limiting example, the multiple image sensors capture images of a driver of the vehicle, an environment of the vehicle, or a combination thereof. The monitoring tool analyzes the images using the one or more machine learning techniques to verify an identity of the driver, monitor driver behavior, recognize one or more license plates in the environment, identify one or more other vehicles in the environment based on the one or more license plates, monitor the one or more other vehicles in the surrounding environment, recognize one or more people in the environment, identify one or more people in the environment, monitor behavior of one or more people in the environment, or a combination thereof, for example.

The monitoring tool is configured to determine whether a behavior or characteristic captured or inferred from one or more image or other sensors of a vehicle complies with one or more health, safety, and environment (HSE) policies using one or more machine learning techniques, and generate a report including at least one of the behavior, an indication of whether the behavior complies with the one or more HSE policies, an HSE policy of the one or more HSE policies with which the behavior violates, or a combination thereof. In some examples, the monitoring tool is configured to disable the first vehicle in response to a determination that the identity of the driver is not associated with the first vehicle. In other examples, the monitoring tool is configured to adjust a field of view of one or more image sensors.

Using the systems and methods for monitoring environments of vehicles described herein reduces accidents and losses (e.g., time, property) and improves occupational conditions in an organization's operating environment. The systems and methods for monitoring environments of vehicles may be used by vehicles patrolling a petrochemical plant or other type of industrial facility, for example. Additionally, the systems and methods can be used in other industries outside of oil and gas or other industrial facilities, for example, in the highway patrol industry, security patrol industry, or like industries in which vehicle patrols can be performed. Thus, the systems and methods as described herein can be used in any environment or industry using vehicles to improve health, safety, and environmental conditions.

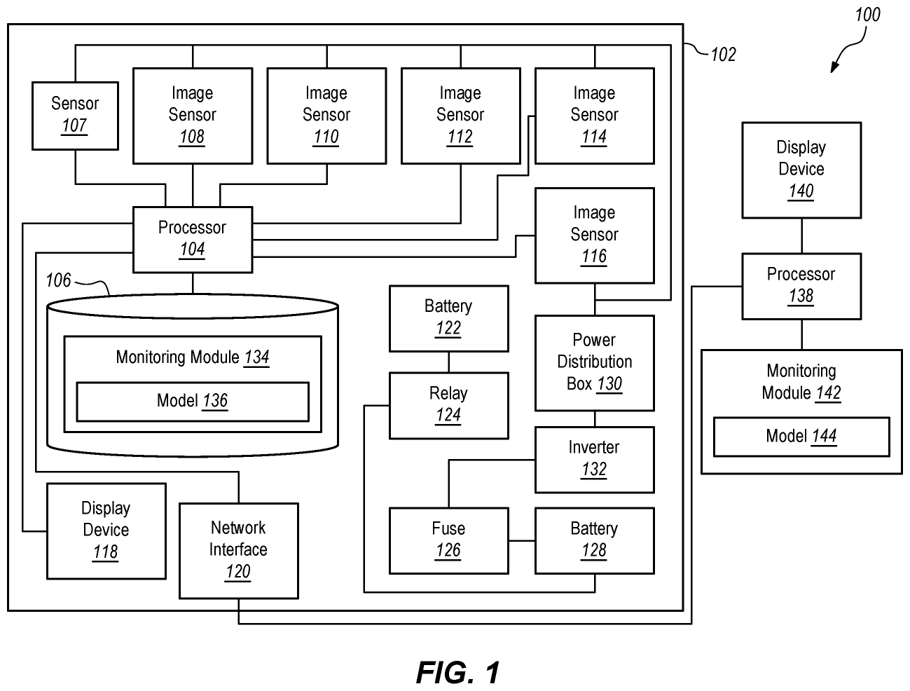

FIG. 1 is a block diagram of a system 100 for monitoring an environment of a vehicle 102, in accordance with certain embodiments. The system 100 monitors the environment of the vehicle 102, for example. As described above, in a non-limiting example, the vehicle 102 includes multiple image sensors 108, 110, 112, 114, 116 and a network interface 120. The multiple image sensors 108, 110, 112, 114, 116 are herein collectively referred to as the image sensors 108-116. The image sensors 108-116 are for capturing one or more images of the environment of the vehicle 102. As described above, the environment of the vehicle 102 includes an interior of the vehicle (e.g., a cabin of the vehicle, a driver of the vehicle, one or more passengers of the vehicle, vehicle instrumentation or indicators), an exterior of the vehicle (e.g., outer components of the vehicle, items within specified distances of the vehicle), or a combination thereof. Each image sensor of the image sensors 108-116 may be disposed at different locations within or outside the vehicle 102 so that the interior of the vehicle 102 as well as the exterior of the vehicle 102 are captured by the fields of view of the image sensors 108-116, although some fields of view may be overlapping. For example, image sensor 108 is disposed to capture an image of the driver of the vehicle 102, image sensor 110 is disposed to capture a forward view of the exterior of the vehicle 102, image sensor 112 is disposed to capture a driver-side view of the exterior of the vehicle 102, image sensor 114 is disposed to capture a side view (e.g., opposite driver-side view) of the exterior of the vehicle 102, image sensor 116 is disposed to capture a rearview of the exterior of the vehicle 102.

The image sensors 108-116 may be complementary metal-oxide-semiconductor (CMOS), back-illuminated CMOS, charge-coupled devices (CCD), electron-multiplying charge-coupled devices (EMCCD), time-of-flight (TOF) sensors, photosensitive devices (e.g., photodetectors, photodiodes, photomultipliers) of light detection and ranging (LiDAR) devices or analog cameras, Internet Protocol (IP) cameras (e.g., network camera), infrared detectors of thermal imaging cameras, components of imaging radars (e.g., transmitter, receiver, antenna), or other like devices used for capturing images. In some embodiments, one or more sensors (e.g., a sensor 107) for capturing information other than images may be employed. Such other information may be cabin temperature, or biometric information of the driver and/or passengers, such as heart rate, temperature, skin moisture (sweat), fingerprints and retinal scans, and so on, and may be used to infer driver or passenger behavior upon which decisions by the system are based. The sensor 107 may be a temperature sensor, an acoustic sensor, an ultrasound sensor, an odor sensor, or other biometric sensor (e.g., a transducer that converts a biometric trait to a signal), for example.

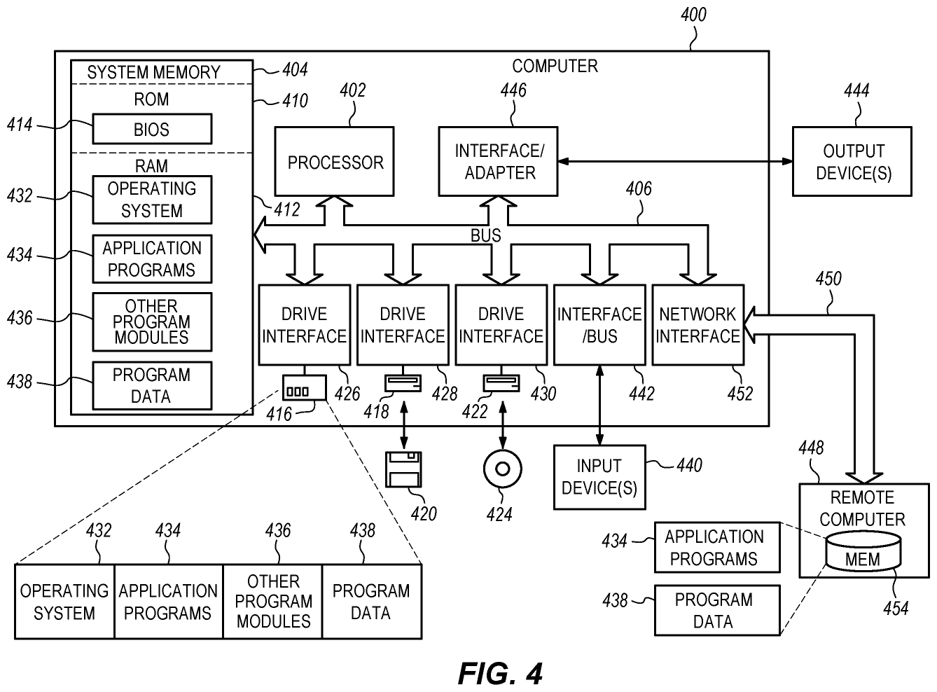

In a non-limiting example, the system 100 includes a monitoring tool to monitor the environment of the vehicle 102. The monitoring tool may be implemented by a computer system described by FIG. 4, for example. The monitoring tool may be implemented by a processor 104 executing machine-readable instructions. The processor 104 may be a processor described by FIG. 4, for example. A computer-readable medium 106 storing a monitoring module 134 may include the machine-readable instructions, for example. The computer-readable medium 106 may be a computer-readable medium described by FIG. 4, for example. The monitoring module 134 may implement a model 136. The monitoring tool local to the vehicle 102 enables the driver to monitor a 360° view around the vehicle 102. In a non-limiting example, the monitoring tool live streams the one or more images captured by the image sensors 108-116 to one or more display devices. The one or more display devices may include a display device 118, a display device 140, or a combination thereof, for example.

In a non-limiting example, the monitoring tool may be remote to the vehicle 102. The remote monitoring tool may be hosted, completely or in part, in the cloud, for example. The remote monitoring tool may be communicatively coupled to multiple vehicles to monitor multiple vehicles and/or facilities, multiple locations within a facility, or a combination thereof, for example. In a non-limiting example, the remote monitoring tool communicates with the vehicle 102 via the network interface 120. In a non-limiting example, the remote monitoring tool and the vehicle 102 may authenticate each other when establishing communications. For example, the remote monitoring tool and the vehicle 102 may exchange security credentials, user identifiers, passwords, security keys, or the like. The network interface 120 may be a wireless connection, as described by FIG. 4, for example. The monitoring tool may be implemented by a processor 138 executing a monitoring module 142. The processor 138 may be a processor described by FIG. 4, for example. The monitoring module 142 may implement a model 144. The remote monitoring tool enables a third-party to perform monitoring for the organization, enables a third-person to monitor the behavior of the driver without interference by the driver, enables an organization to simultaneously monitor the behavior of multiple vehicles, multiple drivers, multiple facilities, or a combination thereof.

In various non-limiting examples, a request to monitor an environment of the vehicle 102 is received by the monitoring tool from an input device or via the network interface 120, as described by FIG. 4. The monitoring tool transmits a signal to the processor 104 to cause the image sensors 108-116 to capture one or more images. The monitoring tool receives the one or more images and other sensor information (cabin temperature, biometric information, etc.). The monitoring tool may store the one or more images (or information), transmit the one or more images, display the one or more images, or a combination thereof. In a non-limiting example, the monitoring tool stores the one or more images or information to a computer-readable medium, such as a database, which stores a record of the one or more images received by the monitoring tool from the vehicle 102 over a time period.

In some non-limiting examples, the monitoring tool receives the request to monitor the environment of the vehicle 102 from a user system via the network interface 120. The user system may be a system as described by FIG. 4, for example. In a non-limiting example, a user of the user system submits the request to monitor the environment of the vehicle 102 via a browser of a computer application installed to the user system. In another non-limiting example, the monitoring tool includes a web-based interface accessible by the browser of the user system.

In various non-limiting examples, the monitoring tool verifies that the user has permission

to request to monitor the environment of the vehicle 102. In some non-limiting examples, the monitoring tool retrieves a role of the user from a security database, or other database storing user access permissions, roles, or a combination thereof, to determine whether the role indicates that the user has permission to request to monitor the environment of the vehicle 102. The security database is a computer-readable medium, such as described by FIG. 4, for example. In some non-limiting examples, in response to an indication that the user has permission to monitor the environment of the vehicle 102, the monitoring tool may determine whether the image sensors 108-116 are powered down. The monitoring tool may determine whether the image sensors 108-116 are powered down by querying a driver of the vehicle 102, for example. In another example, the monitoring tool may determine whether the image sensors 108-116 are powered down by monitoring an output signal of the battery 128.

In a non-limiting example, the monitoring module 134 analyzes one or more of the images captured by the image sensors 108-116, the cabin temperature or biometric information captured by the sensor 107, or a combination thereof, using the model 136 to verify an identity of the driver, monitor driver behavior, recognize one or more license plates in the environment, identify one or more other vehicles in the environment based on the one or more license plates, monitor the one or more other vehicles in the environment, recognize one or more people in the environment, identify one or more people in the environment, monitor behavior of one or more people in the environment, or a combination thereof. In a non-limiting example, the model 136 includes multiple models. For example, the model 136 may include one or more facial recognition models, one or more voice recognition models, one or more fingerprint models, one or more handprint models, one or more retinal models, one or more object recognition models, one or more behavior recognition models, or a combination thereof. In a non-limiting example, the model 136 may be trained using data sets that include one or more sets of data including images captured by image sensors (e.g., analog images, digital images, thermal images, LiDAR images, radar images), environmental temperatures (e.g., cabin temperatures of vehicles, outdoor air temperatures), biometric information, or a combination thereof.

In a non-limiting example, the facial recognition model may be trained using one or more machine learning techniques implementing one or more facial recognition algorithms. A facial recognition algorithm may include one or more of detecting a face in an image, normalizing the face to face toward, extracting one or more features of the face, or comparing the one or more features to faces stored to a database. To detect the face in the image, a Haar Cascade classifier or other machine learning technique trained on images including faces as well as images not including faces, for example. To normalize the face to face a focal point of an image sensor, a machine learning technique may be trained on images including faces having different angles relative to the focal points of image sensors, for example. To extract one or more features of the face, a convolutional neural network (CNN) or other neural network may be trained to extract one or more features (e.g., chin, nose, eyes, points around the eyes, points around the mouth) of the face. To compare the one or more features to faces stored to a database, one or more Euclidean distance metrics may be determined based on the extracted features and compared to one or more Euclidean distance metrics stored to a security database. The security database may include one or more of faces of individuals authorized by an organization, individuals the organization has denied authorization, or a combination thereof. The security database may include different types of access granted or denied to individuals. For example, an individual may be granted access to a first facility of the organization, multiple facilities of the organization, a first vehicle of the organization, multiple vehicles of the organization.

In a non-limiting example, the object recognition model may be trained using one or more

machine learning techniques implementing one or more object recognition algorithms, optical character recognition algorithms, or a combination thereof. An object recognition algorithm may include one or more of detecting one or more objects in an image, normalizing positions of the one or more objects to face toward a focal point of an image sensor, extracting one or more features of the one or more objects, or comparing the one or more objects to objects stored to a database. An optical character recognition algorithm may include one or more of detecting alphanumeric characters in an image, normalizing positions of the alphanumeric characters to face toward the focal point of the image sensor, detecting one or more words, translating the one or more words, comparing the alphanumeric characters to alphanumeric characters stored to a database. In a non-limiting example, to extract one or more objects in the image, a convolutional neural network (CNN) or other neural network may be trained to detect one or more objects in the image.

In a non-limiting example, to detect the object, the alphanumeric characters, or a combination thereof, a computer vision technique or other machine learning technique trained on images including objects associated with the organization as well as images not including objects associated with the organization, for example. To normalize the positions of the one or more objects, alphanumeric characters, or the combination thereof, to face toward a focal point of an image sensor, a machine learning technique may be trained on images including objects, alphanumeric characters, of a combination thereof, having different angles relative to the field of views of image sensors, for example. In a non-limiting example, to extract the one or more features of the one or more objects, the optical character recognition algorithm may be used. The one or more objects, alphanumeric characters, or the combination thereof, may be compared to data of the security database, in a non-limiting example. The security database may include one or more vehicles authorized by an organization, one or more vehicles the organization has denied authorization, or a combination thereof. The security database may include a license plate associated with a vehicle, a vehicle identification number (VIN), a color of the vehicle, a make of the vehicle, a model of the vehicle, or a combination thereof.

In a non-limiting example, the behavior recognition model may be trained using one or more machine learning techniques implementing one or more behavior recognition algorithms. The one or more behavior recognition algorithms may include a behavior recognition algorithm for human behavior, a behavior recognition algorithm for vehicular behavior, or a combination thereof. A behavior recognition algorithm may include one or more of detecting one or more of a face, a body, a vehicle, or a combination thereof, in an image, a temperature outside of a threshold range (e.g., above an upper limit, below a lower limit, outside a specified standard deviation), biometric data exceeding a tolerance (e.g., above an upper limit, below a lower limit, outside a specified standard deviation), or a combination thereof; extracting one or more features of the face, the body, the vehicle, or the combination thereof; determining a behavior of an individual based on the features of the face or the body, a behavior of the vehicle, or the combination thereof; and comparing the one or more features to one or more behaviors stored to a database. To detect the face, the body, the vehicle, or the combination thereof, in the image, a Haar Cascade classifier or other machine learning technique trained on images including faces, bodies, vehicles, or the combination thereof, as well as images not including faces, bodies, vehicles, or the combination thereof, for example. To extract one or more features of the face, the body, the vehicle, or the combination thereof, a convolutional neural network (CNN) or other neural network may be trained to extract one or more features. To determine the behavior, a sequence of images may be analyzed. The determined behavior may be compared one or more HSE policies stored to an HSE policy database, for example. The HSE policy database may include one or more HSE policies of an organization. For example, the HSE policies may be different between different facilities of the organization, same between same types of facilities of the organization, or may be different based on different locations within a facility.

In a non-limiting example, the monitoring module 134 or the monitoring module 142 is configured to generate a report including at least one of the behavior, an indication of whether the behavior complies with the one or more HSE policies, an HSE policy of the one or more HSE policies with which the behavior violates, or a combination thereof. In a non-limiting example, the processor 104 causes the display device 118 to display the report. In another example, the processor 138 causes the display device 140 to display the report. The display device 118 or the display device 140 may be an output device described by FIG. 4, for example. In some examples, the monitoring module 134 or the monitoring module 142 is configured to control one or more components of the vehicle 102 in response to one or more of a determination that the driver is not authorized to be within the facility, a determination that the identity of the driver is not associated with the vehicle 102, or any other rule or policy violation. For example, the monitoring module 142 is configured to disable (e.g., prevent operations of) the vehicle 102 in response to one or more of a determination that the driver is not authorized to be within the facility, a determination that the identity of the driver is not associated with the vehicle 102, or any other rule or policy violation. In other examples, the monitoring module 134 or the monitoring module 142 is configured to adjust a field of view of one or more of the image sensors 108-116. For example, a field of view of the image sensor 108 may be increased (zoom in) to capture an enhanced view of a face, a body, an object, or a combination thereof. In another example, a field of view of the image sensor 110 may be adjusted to a capture a different angle of view (e.g., adjusted from a forward view to a view that includes both a forward view and a driver-side view, or a widened field).

In a non-limiting example, the vehicle 102 includes a power supply system for the image sensors 108-116. The power supply system includes a power distribution box 130, an inverter 132, a fuse 126, and a battery 128. The battery 128 of the power supply system may be coupled to a battery 122 of the vehicle 102 via a relay 124. The fuse 126 couples to the battery 128 and the inverter 132. The inverter 132 couples to the power distribution box 130. The power distribution box 130 distributes power to the image sensors 108-116.

System 100 of FIG. 1 may be partially or wholly implemented, in any combination, as part of one or more systems used by one or more organizations for monitoring environments of vehicles. While the examples described herein refer to a single organization, one skilled in the art will recognize that the systems and methods described herein may provide services to multiple organizations. In a non-limiting example, multiple user systems from multiple organizations may transmit requests to monitor one or more vehicles or one or more environments of the one or more vehicles. The systems may include multiple databases, one or more for each organization of the multiple organizations. Processing a request to monitor the one or more vehicles or the one or more environments of the one or more vehicles may include identifying an organization associated with the request. The system may use the organization identifier to determine a relevant database to use in processing the request, a vehicle to interface with to perform the monitoring, or a combination thereof.

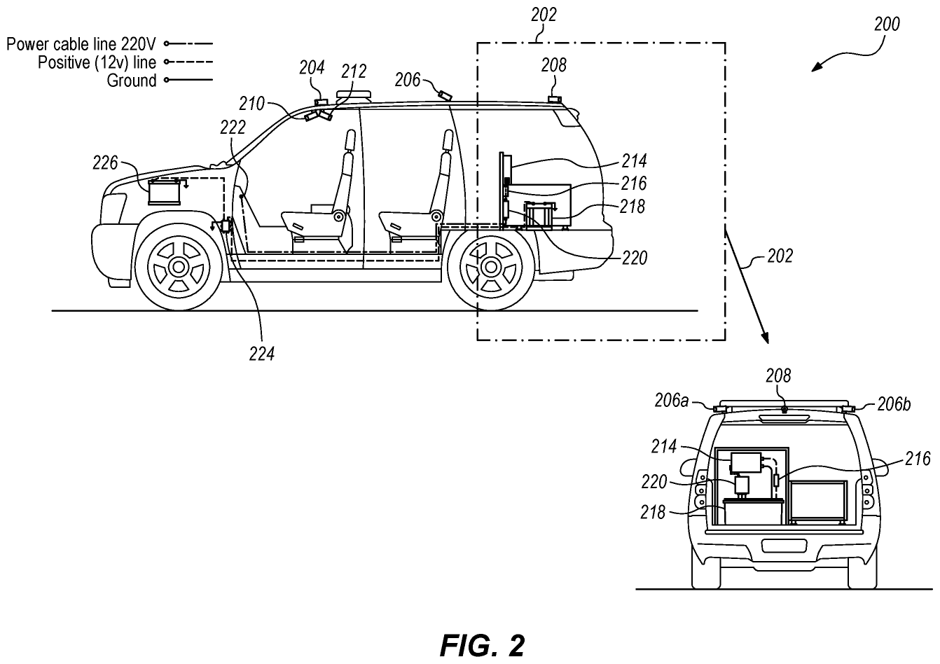

FIG. 2 is an example system for monitoring an environment of a vehicle 200, in accordance with certain embodiments. The system may be the system 100 of FIG. 1, and the vehicle 200 may be the vehicle 102 of FIG. 1, for example. The vehicle 200 includes an image sensor 204, image sensors 206, an image sensor 208, an image sensor 210, an image sensor 212, an inverter 214, a fuse box 216, a battery 218, a power distribution box 220, a computing device 222, a relay 224, and a battery 226. The image sensors 204, 206, 208, 210, 212 may herein collectively be referred to as the image sensors 204-212. A view 202 is a view from a rear of the vehicle 200 and shows image sensors 206 as an image sensor 206a and an image sensor 206b, which are collectively referred to as the image sensors 206.

In a non-limiting example, the inverter 214, the fuse box 216, the battery 218, and the

power distribution box 220 may be the power supply system for image sensors described by FIG. 1, for example. The inverter 214 may be the inverter 132, for example. The fuse box 216 may include the fuse 126, for example. The battery 218 may be the battery 128, for example. The power distribution box 220 may be the power distribution box 130, for example. The image sensors 204-212 may be the image sensors 108-116, for example. The power supply system for the image sensors 204-212 couple to the battery 226 via the relay 224, for example. In a non-limiting example, the computing device 222 couples to the battery 226 via the relay 224. In a non-limiting example, the power supply system for the image sensors 204-212 is housed within a secure location in the rear of the vehicle 200. The secure location may require a specified access level, a key, or a combination thereof, to gain entry, for example.

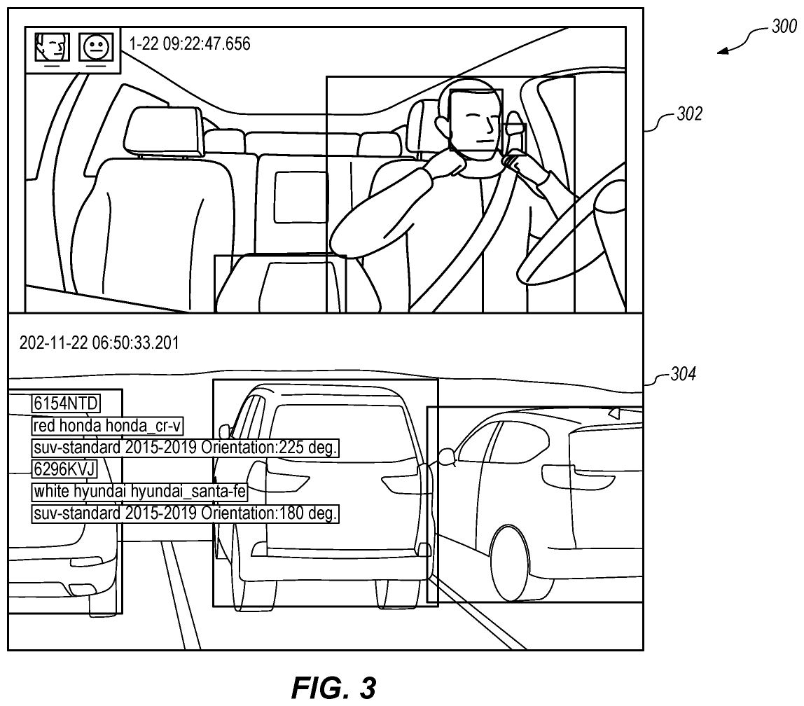

FIG. 3 is an example output 300 of a system or method for monitoring an environment of a vehicle, in accordance with certain embodiments. The system may be the system 100 of FIG. 1, for example. The vehicle may be the vehicle 102 of FIG. 1 or the vehicle 200 of FIG. 2, for example. The output 300 may be displayed on a display device (e.g., the display device 118 of FIG. 1, the display device 140 of FIG. 1), for example. The output 300 includes an image 302 and an image 304. The image 302 may be captured by a first image sensor of the vehicle, and the image 304 may be captured by one or more other image sensors of the vehicle. The image 304 may be a composite of images captured by multiple image sensors, for example. The first image sensor and the one or more other image sensors of the vehicle may be the image sensors 108-116 of FIG. 1 or the image sensors 204-212 of FIG. 2, for example.

In a non-limiting example, a monitoring tool receives the image 302, identifies a driver of

the vehicle, and causes a display device to display the image 302. In a non-limiting example, the monitoring tool may cause the display device to display the identity (e.g., name, employee number, driver license number) of the driver. In another non-limiting example, the monitoring tool may determine a behavior of the driver and determine whether the behavior complies with one or more HSE policies. The monitoring tool may cause the display device to display an indicator indicating whether the behavior complies with the one or more HSE policies. In a non-limiting example, in response to a determination that the behavior violates at least one of the one or more HSE policies, the monitoring tool may cause the display device to display an image or video (e.g., an “X,” a frown emoji), a color (e.g., red), a word (e.g., “non-compliant,” “fail,” “correction needed”), or the like to indicate the violation.

In another non-limiting example, the monitoring tool receives the image 304, identifies the vehicle within the image, and causes the display device to display the image 304. In a non-limiting example, the monitoring tool causes the display device to display the identity (e.g., license plate, VIN, color, make, model) of the vehicle. In another non-limiting example, the monitoring tool may determine a behavior of the vehicle and determine whether the vehicle complies with one or more

HSE policies. The monitoring tool may cause the display device to display an indicator indicating whether the behavior complies with the one or more HSE policies. In a non-limiting example, in response to a determination that the behavior violates at least one of the one or more HSE policies, the monitoring tool may cause the display device to display an image or video (e.g., an “X,” a frown emoji), a color (e.g., red), a word (e.g., “non-compliant,” “fail,” “correction needed”), or the like to indicate the violation.

While the examples described herein refer to a single organization or a single facility, one skilled in the art will recognize that the monitoring tool described herein may provide services to multiple facilities of a single organization, individual facilities of multiple organizations, or multiple organizations each having a different number of facilities. In a non-limiting example, multiple vehicle systems from multiple organizations may transmit requests for monitoring services via multiple service account servers. The monitoring tool may include multiple HSE policy databases, one or more for each organization of the multiple organizations. Processing a request for a monitoring service may include one or more of identifying an organization associated with the request, or a facility associated with the request. The monitoring tool may use the organization identifier, the facility identifier, or a combination thereof, to determine a relevant HSE policy to use in processing the request. Using the monitoring tool described herein enhances a maturity of an organization's HSE policy by improving identification of risks within a facility patrolled by the vehicle.

In view of the foregoing structural and functional description, those skilled in the art will

appreciate that portions of the embodiments may be embodied as a method, data processing system, or computer program product. Accordingly, these portions of the present embodiments may take the form of an entirely hardware embodiment, an entirely software embodiment, or an embodiment combining software and hardware, such as shown and described with respect to the computer system of FIG. 4. Furthermore, portions of the embodiments may be a computer program product on a computer-usable storage medium having computer readable program code on the medium. Any non-transitory, tangible storage media possessing structure may be utilized including, but not limited to, static and dynamic storage devices, hard disks, optical storage devices, and magnetic storage devices, but excludes any medium that is not eligible for patent protection under 35 U.S.C. § 101 (such as a propagating electrical or electromagnetic signal per se). As an example and not by way of limitation, a computer-readable storage media may include a semiconductor-based circuit or device or other IC (such as, for example, a field-programmable gate array (FPGA) or an ASIC), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. A computer-readable non-transitory storage medium may be volatile, nonvolatile, or a combination of volatile and non-volatile, where appropriate.

Certain embodiments have also been described herein with reference to block illustrations of methods, systems, and computer program products. It will be understood that blocks of the illustrations, and combinations of blocks in the illustrations, can be implemented by computer-executable instructions. These computer-executable instructions may be provided to one or more processor of a general purpose computer, special purpose computer, or other programmable data processing apparatus (or a combination of devices and circuits) to produce a machine, such that the instructions, which execute via the processor, implement the functions specified in the block or blocks.

These computer-executable instructions may also be stored in computer-readable memory that can direct a computer or other programmable data processing apparatus to function in a particular manner, such that the instructions stored in the computer-readable memory result in an article of manufacture including instructions which implement the function specified in the flowchart block or blocks. The computer program instructions may also be loaded onto a computer or other programmable data processing apparatus to cause a series of operational blocks to be performed on the computer or other programmable apparatus to produce a computer implemented process such that the instructions which execute on the computer or other programmable apparatus provide blocks for implementing the functions specified in the flowchart block or blocks.

FIG. 4 is a block diagram of a computer system 400 that can be employed to execute a system for analyzing ransomware threat intelligence in accordance with certain embodiments described. Computer system 400 can be implemented on one or more general purpose networked computer systems, embedded computer systems, routers, switches, server devices, client devices, various intermediate devices/nodes or standalone computer systems. Additionally, computer system 400 can be implemented on various mobile clients such as, for example, a personal digital assistant (PDA), laptop computer, pager, and the like, provided it includes sufficient processing capabilities.

Computer system 400 includes processing unit 402, system memory 404, and system bus 406 that couples various system components, including the system memory 404, to processing unit 402. Dual microprocessors and other multi-processor architectures also can be used as processing unit 402. System bus 406 may be any of several types of bus structure including a memory bus or memory controller, a peripheral bus, and a local bus using any of a variety of bus architectures. System memory 404 includes read only memory (ROM) 410 and random access memory (RAM) 412. A basic input/output system (BIOS) 414 can reside in ROM 410 containing the basic routines that help to transfer information among elements within computer system 400.

Computer system 400 can include a hard disk drive 416, magnetic disk drive 418, e.g., to read from or write to removable disk 420, and an optical disk drive 422, e.g., for reading CD-ROM disk 424 or to read from or write to other optical media. Hard disk drive 416, magnetic disk drive 418, and optical disk drive 422 are connected to system bus 406 by a hard disk drive interface 426, a magnetic disk drive interface 428, and an optical drive interface 430, respectively.

The drives and associated computer-readable media provide nonvolatile storage of data, data structures, and computer-executable instructions for computer system 400. Although the description of computer-readable media above refers to a hard disk, a removable magnetic disk and a CD, other types of media that are readable by a computer, such as magnetic cassettes, flash memory cards, digital video disks and the like, in a variety of forms, may also be used in the operating environment; further, any such media may contain computer-executable instructions for implementing one or more parts of embodiments shown and described herein.

A number of program modules may be stored in drives and RAM 412, including operating system 432, one or more computer application programs 434, other program modules 436, and program data 438. In some examples, the computer application programs 434 can include one or more sets of computer-executable instructions of the monitoring module 134 or the monitoring module 142 and the program data 438 can include data of a security database, an HSE policy database, or one or more images captured by one or more image sensors of one or more vehicles. The computer application programs 434 and program data 438 can include functions and methods programmed to perform the methods to monitor the environment of the vehicle, such as shown and described herein.

A user may enter commands and information into computer system 400 through one or more input devices 430, such as a pointing device (e.g., a mouse, touch screen), keyboard, microphone, joystick, game pad, scanner, and the like. For instance, the user can employ input device 430 to edit or modify the monitoring tool, data stored to one or more databases, or a combination thereof. These and other input devices 430 are often connected to processing unit 402 through a corresponding port interface 442 that is coupled to the system bus, but may be connected by other interfaces, such as a parallel port, serial port, or universal serial bus (USB). One or more output devices 444 (e.g., display, a monitor, printer, projector, or other type of displaying device) is also connected to system bus 406 via interface 446, such as a video adapter.

Computer system 400 may operate in a networked environment using logical connections

to one or more remote computers, such as remote computer 448. Remote computer 448 may be a workstation, computer system, router, peer device, or other common network node, and typically includes many or all the elements described relative to computer system 400. The logical connections, schematically indicated at 450, can include a local area network (LAN) and a wide area network (WAN). When used in a LAN networking environment, computer system 400 can be connected to the local network through a network interface or adapter 452. When used in a WAN networking environment, computer system 400 can include a modem, or can be connected to a communications server on the LAN. The modem, which may be internal or external, can be connected to system bus 406 via an appropriate port interface. In a networked environment, computer application programs 434 or program data 438 depicted relative to computer system 400, or portions thereof, may be stored in a remote memory storage device 454.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including, ” “comprises”, and/or “comprising.” and variations thereof, when used in this specification, specify the presence of stated features, integers, blocks, operations, elements, and/or components, but do not preclude the presence or addition of one or more other features, integers, blocks, operations, elements, components, and/or groups thereof.

Terms of orientation are used herein merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, as used herein, the terms “coupled” or “coupled to” or “connected” or “connected to” or “attached” or “attached to” may indicate establishing either a direct or indirect connection, and is not limited to either unless expressly referenced as such.

While the description has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the description without departing from the essential scope thereof. Therefore, it is intended that the invention not be limited to the particular embodiments described, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

What is claimed is:

1. A monitoring tool, implemented by a processor, configured to:
determine whether a behavior inferred from capture of information by one or more sensors of a vehicle complies with one or more health, safety, and environment (HSE) policies using one or more machine learning techniques; and
generate a report including at least one of the behavior, an indication of whether the behavior complies with the one or more HSE policies, an HSE policy of the one or more HSE policies with which the behavior violates, or a combination thereof.

2. The monitoring tool of claim 1, wherein the vehicle is a first vehicle, and wherein the monitoring tool is further configured to:
identify at least one of an identity of a driver of the first vehicle or a license plate of a second vehicle using the one or more machine learning techniques; and
compare the identity of the driver of the vehicle or the license plate of the second vehicle to data of a security database to verify whether the driver of the first vehicle or the license plate of the second vehicle are an authorized driver of the first vehicle or an authorized second vehicle, respectively.

3. The monitoring tool of claim 2, wherein the monitoring tool is further configured to:
identify at least one of a behavior of the driver of the first vehicle or a behavior of the second vehicle; and
compare the at least one of the behavior of the driver of the first vehicle or the behavior of the second vehicle to data of a HSE policy database to verify whether the behavior of the driver of the first vehicle or the behavior of the second vehicle complies with the one or more HSE policies.

4. The monitoring tool of claim 3, wherein the monitoring tool is further configured to disable the first vehicle in response to a determination that the identity of the driver is not associated with the first vehicle.

5. The monitoring tool of claim 4, wherein the monitoring tool is further configured to adjust a field of view of one or more image sensors.

6. A method, comprising:
live-streaming one or more images captured by one or more image sensors;
verifying at least one of an identity of a driver of a first vehicle or a license plate of a second vehicle based on at least one of the one or more images or other sensor information using one or more machine learning techniques; and
generating a report including the at least one of the identity of the driver of the first vehicle or the license plate of the second vehicle.

7. The method of claim 6, further comprising disabling the first vehicle in response to verification that the identity of the driver is not associated with the first vehicle.

8. The method of claim 7, wherein verifying the at least one of the identity of the driver of the first vehicle or the license plate of the second vehicle based on the at least one of the one or more images using one or more machine learning techniques comprises:
identifying the driver of the first vehicle or the license plate of the second vehicle based on the at least one of the one or more images using one or more machine learning techniques; and
comparing the driver of the first vehicle or the license plate of the second vehicle to data of a security database to verify whether the driver of the first vehicle or the license plate of the second vehicle are an authorized driver of the first vehicle or an authorized second vehicle, respectively.

9. The method of claim 8, further comprising:
monitoring driver behavior; and
generating a report including the driver behavior.

10. The method of claim 9, further comprising adjusting a field of view of one or more image sensors to monitor the driver behavior.

11. The method of claim 10, further comprising comparing the driver behavior to one or more health, safety, and environment policies of an organization.

12. The method of claim 6, further comprising monitoring the second vehicle.

13. The method of claim 12, further comprising adjusting a field of view of one or more image sensors to monitor the second vehicle.

14. A computer-readable medium storing machine-readable instructions, which when executed by a processor, cause the processor to:
determine whether a behavior inferred from capture of one or more images or other sensor information of a vehicle complies with one or more health, safety, and environment (HSE) policies using one or more machine learning techniques; and
generate a report including at least one of the behavior, an indication of whether the behavior complies with the one or more HSE policies, an HSE policy of the one or more HSE policies with which the behavior violates, or a combination thereof.

15. The computer-readable medium of claim 14, wherein the processor is further operable to control one or more components of the vehicle in response to a determination that the behavior captured by the one or more images violates the HSE policy of the one or more HSE policies.
